(19) United States
(12) Patent Application Publication
(10) Pub. No.: US 2020/0324617 A1
(43) Pub. Date: Oct. 15, 2020

(54) CIRCUIT PROTECTION FOR TRANSPORTATION AUXILIARY POWER UNIT

(71) Applicant: CARRIER CORPORATION, Palm Beach Gardens, FL (US)

(72) Inventors: Richard Conway, Athens, GA (US); Greg W. Turner, Nicholson, GA (US); Stephen Lee, Hull, GA (US)

(21) Appl. No.: 16/813,786

(22) Filed: Mar. 10, 2020

Related U.S. Application Data
(60) Provisional application No. 62/831,968, filed on Apr. 10, 2019.
(60) Provisional application No. 62/857,992, filed on Jun. 6, 2019.

(51) Int. Cl. B60H 1/00; B60K 25/00

(52) U.S. Cl. CPC B60H 1/00428; B60K 25/00; B60H 1/00378

(57) ABSTRACT

An illustrative example embodiment of an auxiliary power system for a transport vehicle includes an APU, at least one circuit configured to supply power from the APU to at least one load, and a circuit protection device associated with the at least one circuit. The circuit protection device is configured to protect against an arc fault condition.

### CROSS-REFERENCE TO RELATED APPLICATIONS

This application claims priority to U.S. Provisional Application No. 62/831,968, filed on Apr. 10, 2019 and U.S. Provisional Application No. 62/857,992, filed on Jun. 6, 2019.

### BACKGROUND

Auxiliary power units (APUs) are useful in a variety of circumstances. In the transportation industry, for example, an APU may be provided on a truck for providing electrical power when the main engine is not in use. Such APUs are useful for powering air conditioning or refrigeration systems on-board such vehicles.

### SUMMARY

An illustrative example embodiment of an auxiliary power system for a transport vehicle includes an APU, at least one circuit configured to supply power from the APU to at least one load, and a circuit protection device associated with the at least one circuit. The circuit protection device is configured to protect against an arc fault condition.

### BRIEF DESCRIPTION OF THE DRAWINGS

FIG. 1 schematically illustrates selected portions of a vehicle including an auxiliary power system with circuit protection designed according to an embodiment of this disclosure.

FIG. 2 schematically illustrates selected features of an example auxiliary power system with circuit protection designed according to an embodiment of this disclosure.

### DETAILED DESCRIPTION

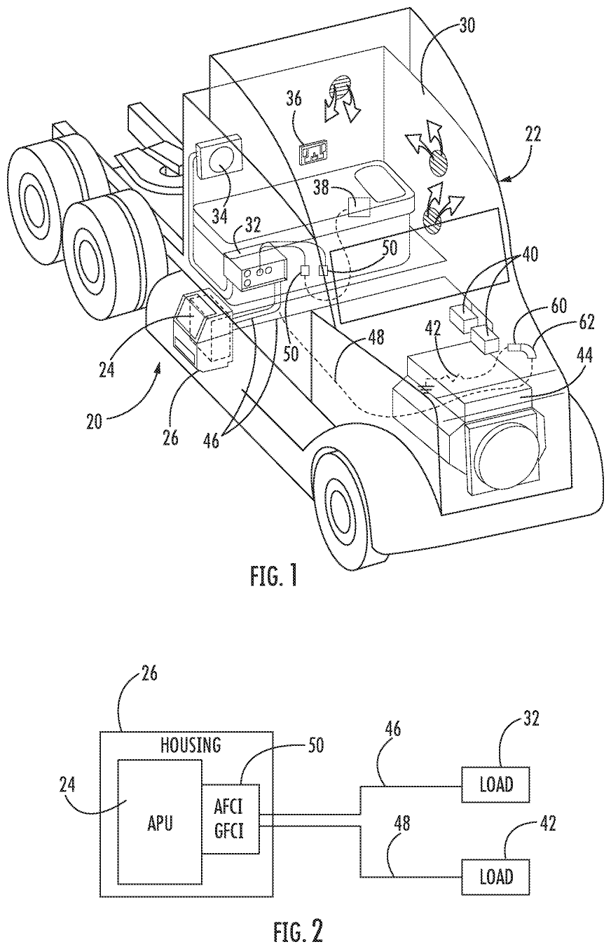

FIG. 1 schematically illustrates an auxiliary power system 20 on-board a vehicle 22, which in this example is a truck. The auxiliary power system 20 includes an auxiliary power unit (APU) 24 supported within a housing 26 on-board the vehicle 22. The housing 26 in this example provides protection for the APU 24 from the external environment. The APU 24 in some embodiments includes a diesel engine and a generator or alternator that operate in a known manner for providing electrical power.

The APU 24 provides electrical power to a plurality of devices or loads on-board the vehicle 22. In the illustrated example, the APU 24 provides power for use within a cabin 30 of the vehicle 22. A climate control unit 32 provides heating and cooling within the cabin 30 and utilizes electrical power available from the APU 24. The climate control unit 32 has an associated condenser 34 and can be controlled through a control panel 36, which also receives power available from the APU 24. Other devices, such as a personal device 38, within the cabin 30 may be plugged into an appropriate outlet within the cabin 30 to draw electrical power from the APU 24 as may be needed. The power provided by the APU 24 for the devices associated with the cabin 30 or any personal devices brought into the cabin 30 can be referred to as on-board or hotel power. In some embodiments, such hotel power is 120 volt, 60 Hertz alternating current power.

Although not illustrated, the vehicle 22 may be associated with a trailer that includes a refrigeration or transportation cooling unit to maintain a desired temperature in the trailer. The APU 24 may provide the electrical power for such a refrigeration or transportation cooling unit.

The APU 24 also provides power for charging batteries 40 on-board the vehicle 22. Another device in the illustrated example is a heater 42 associated with an engine 44 of the vehicle 22. The heater 42 is considered a supplemental or accessory device, which in this example is not permanently connected to the APU 24. The engine 44 is the primary source of motive power for the vehicle 22. The APU is used for supplying electrical power while the engine 44 is off, the vehicle 22 is stationary, or in circumstances in which deriving electrical power through an alternator associated with the engine 44 is undesirable.

The example auxiliary power system 20 includes conductors or circuitry 46 installed on the vehicle 22 for making a permanent or continuous connection between the APU 24 and selected electrically powered devices on the vehicle 22. In this example, the circuitry 46 permanently connects the APU 24 to the climate control unit 32, the control panel 36 and the batteries 40. Another circuit 48 is connected with the APU 24 and selectively coupled to the heater 42 by an individual such as the driver or owner of the vehicle 22.

Circuit protection devices 50 are associated with the circuits 46 and 48 to protect against faults that may occur. The circuit protection devices 50 in this example are configured for arc fault protection and ground fault protection. In some embodiments at least one circuit protection device 50 is configured to protect against ground faults and at least one other circuit protection device 50 is configured to protect against arc faults. The circuit protection devices include components that work in a manner consistent with commercially available ground fault and arc fault protection components.

In the example of FIG. 1, the circuit protection devices 50 are situated within the cabin 30 where they are protected from the external environment. At least one of the circuit protection devices 50 is integrated into an outlet that is useful for plugging in a personal device 38 to obtain electrical power from the APU 24.

Another example embodiment that includes circuit protection is shown in FIG. 2. At least one circuit protection device 50 is associated with the APU 24 within the housing 26 where the circuit protection device 50 is shielded from exposure to the environment. The illustrated example circuit protection device 50 is configured to protect against arc faults and ground faults.

In FIG. 1, the engine heater 42 includes a terminal 60, such as a plug or an outlet. The heater terminal 60 is selectively connected with the APU 24 through the circuit 48. In the illustrated example, the circuit 48 includes a connector 62, such as an outlet or a plug, designed to establish an electrically conductive connection with the terminal 60. Depending on the location of the terminal 60, it may be possible for corrosion to develop on the conductive portions of the terminal 60. It is also may be possible for corrosion to develop on the connector 62 on the end of the circuit 48. One feature of the circuit protection device 50 associated with the circuit 48 is that it protects against any arcing that may occur as a result of the presence of corrosion at the terminal 60 or the connector 62. Typical arc protection devices that are included in building electrical systems are designed to address situations where a conductor may be damaged, such as frayed wiring. The use of an arc protection device to guard against potential arcing associated with corrosion is unique to the disclosed example embodiments. The combination of arc fault protection and ground fault protection enhances the auxiliary power system 20.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An auxiliary power system for a transport vehicle, comprising:
an auxiliary power unit (APU) that is configured to provide electrical power;
at least one circuit configured to supply power from the APU to at least one load; and
a circuit protection device associated with the at least one circuit, the circuit protection device being configured to protect against an arc fault condition.

2. The auxiliary power system of claim 1, wherein the circuit protection device is configured to protect against a ground fault condition.

3. The auxiliary power system of claim 1, wherein the at least one circuit includes a conductor having a connector near an end of the conductor and the circuit protection device protects against an arc fault condition associated with corrosion on the connector.

4. The auxiliary power system of claim 3, comprising an engine heater including a terminal configured to establish an electrically conductive connection with the connector and wherein the circuit protection device protects against an arc fault condition associated with corrosion on the terminal.

5. The auxiliary power system of claim 1, wherein
the transport vehicle comprises a cabin and a climate control unit for heating or cooling the cabin; and
the climate control unit draws electrical power from the APU.

6. The auxiliary power system of claim 1, comprising a housing and wherein the APU is situated inside the housing and the circuit protection device is situated in the housing.

7. A transport vehicle, comprising:
a cabin;
a climate control unit configured to heat or cool the cabin;
an auxiliary power unit (APU) that is configured to provide electrical power to at least the climate control unit;
at least one circuit configured to supply power from the APU to at least one other load associated with the vehicle; and
a circuit protection device associated with the APU, the circuit protection device being configured to protect against an arc fault condition.

8. The transport vehicle of claim 7, wherein the circuit protection device is configured to protect against a ground fault condition.

9. The transport vehicle of claim 7, wherein the at least one circuit includes a conductor having a connector near an end of the conductor and the circuit protection device protects against an arc fault condition associated with corrosion on the connector.

10. The transport vehicle of claim 9, comprising
an engine that provides a motive force for driving the vehicle; and
a heater configured to heat the engine, the heater including a terminal configured to establish an electrically conductive connection with the connector, and
wherein the circuit protection device protects against an arc fault condition associated with corrosion on the terminal.

11. The transport vehicle of claim 7, comprising a housing and wherein the APU is situated inside the housing and the circuit protection device is situated in the housing.

12. A transport vehicle, comprising:
an engine that provides a motive force for driving the vehicle;
a heater configured to heat the engine, the heater including an electrically conductive terminal;
an auxiliary power unit (APU) that is configured to provide electrical power to at least the heater;
at least one circuit configured to supply power from the APU to at least the heater, the at least one circuit including a connector configured to establish an electrically conductive connection with the terminal; and
a circuit protection device associated with the at least one circuit, the circuit protection device being configured to protect against an arc fault condition associated with corrosion on at least one of the terminal or the connector.

13. The transport vehicle of claim 12, wherein the circuit protection device is configured to protect against a ground fault condition.

14. The transport vehicle of claim 12, comprising a housing and wherein the APU is situated inside the housing and the circuit protection device is situated in the housing.

15. The transport vehicle of claim 12, comprising:
a cabin; and
a climate control unit configured to heat or cool the cabin, and
wherein the APU provides electrical power to the climate control unit.
